(19) United States
(12) Patent Application Publication
(10) Pub. No.: US 2010/0312793 A1
(43) Pub. Date: Dec. 9, 2010

(54) DISPLAYING RELEVANCY OF RESULTS FROM MULTI-DIMENSIONAL SEARCHES USING HEATMAPS

(75) Inventors: Eric M. Brown, Raleigh, NC (US); Ronny A. Pena, Bronx, NY (US); Ajamu A. Wesley, Marlborough, MA (US)

Correspondence Address: IBM RALEIGH IPLAW (DG);C/O DELIZIO GILLIAM, PLLC, 15201 MASON ROAD, SUITE 1000-312, CYPRESS, TX, 77433, US

(73) Assignee: International Business Machines Corporation, Armork, NY (US)

(21) Appl. No.: 12/480,405

(22) Filed: Jun. 8, 2009

(51) Int. Cl. G06F 17/30

(52) U.S. Cl. 707/770; 707/759; 707/713

(57) ABSTRACT

A multi-dimensional search can be performed for each search term within a search phrase. Individual relevancies that represent the relevance to each search term can be determined for each search result. An overall relevancy can be calculated based on the individual relevancies. The individual relevancies can be displayed using a heatmap that depicts the relationship between the individual relevancies. In addition, the heatmap may be color-coded based on the overall or individual relevancies.

### BACKGROUND

Embodiments of the inventive subject matter generally relate to the field of multi-dimensional searching, and, more particularly, to displaying relevancy of results from multi-dimensional searches using heatmaps.

Search results are typically displayed in a list ranked by relevancy to a search phrase. The relevancy is one-dimensional in that the relevancy is based upon the entire search phrase. Search phrases can comprise multiple search terms, so it may be difficult to determine the appropriateness of search results to individual search terms based on the one-dimensional relevancy. For example, a user may perform a search for a search phrase, “printer model set-up fax.” The search phrase is made up of two search terms “printer model” and “set-up fax.” Frequent appearance of the search term “printer model” in certain documents may cause the relevancy to be biased toward “printer model,” so these documents may be ranked very high in relevancy. But these documents may not be particularly useful to the user who is looking for instructions for setting-up the fax function of the printer. In this case, “set-up fax” is the primary objective of the search, but the overall relevancy may not indicate which documents are the most relevant to the “set-up fax” search term.

### SUMMARY

Embodiments include a method directed to determining a plurality of search terms from a search phrase. In some embodiments, a search query can be submitted for each of the plurality of search terms on a plurality of documents. Individual relevancies of each of the plurality of documents can be determined with respect to each of the plurality of search terms. An overall relevancy can be computed for each of the plurality of documents based on the individual relevancies. A graphical representation of the individual relevancies and the overall relevancies can be displayed.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram of displaying a heatmap to depict relevancies of multi-dimensional search results.

FIG. 2 is a flowchart depicting example operations for displaying a heatmap to depict relevancies of multi-dimensional search results.

FIG. 3 is a flowchart of example operations for creating a metadata file for a document.

FIG. 4 depicts an example computer system.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to depicting heatmaps as three-dimensional surface plots, heatmaps may be depicted as two-dimensional plots, shaded matrices, etc. In other instances, well-known instruction instances, protocols, structures, and techniques have not been shown in detail in order not to obfuscate the description.

Relevancies that are based on entire search phrases can be biased toward individual search terms and may not accurately represent other search terms within the search phrases. Relevancy may be biased towards a particular search term if the particular search term appears more frequently than other search terms in the search results, the certain search term appears in titles, subjects, and headers of the search results, etc. If a user searches for “printer model set-up fax,” it is clear that the “set-up fax” search term is most important. The purpose of the “printer model” search term is to refine the search. It is likely that “printer model” will appear more frequently in the search results than “set-up fax,” so the relevance of the search phrase “printer model set-up fax” may be biased toward “printer model.” A multi-dimensional search can be performed for each search term within a search phrase. Individual relevancies that represent the relevance to each search term can be determined for each search result. An overall relevancy can be calculated based on the individual relevancies. The individual relevancies can be displayed using a heatmap that depicts the relationship between the individual relevancies. In addition, the heatmap may be color-coded based on the overall or individual relevancies.

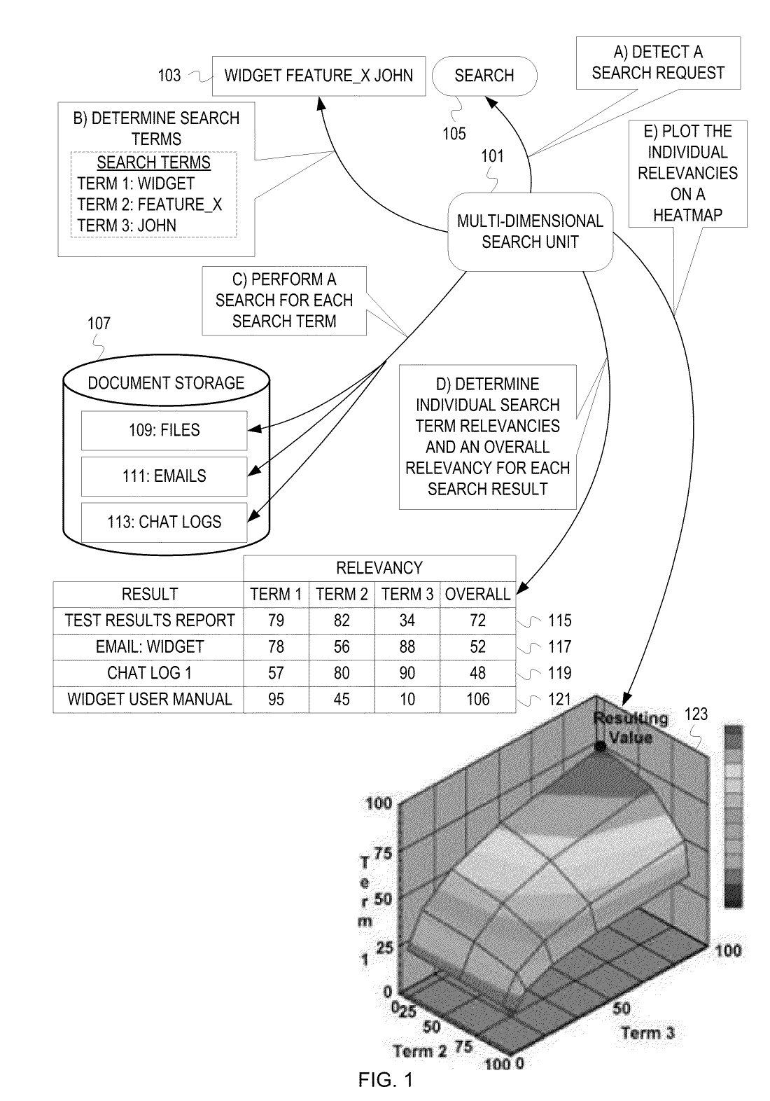

FIG. 1 is an example conceptual diagram of displaying a heatmap to depict relevancies of multi-dimensional search results. At stage A, a multi-dimensional search unit 101 detects a search request. In this example, the multi-dimensional search unit 101 detects a click on a search button 105.

At stage B, the multi-dimensional search unit 101 determines search terms from a search phrase entered into a search text box 103. A search phrase can comprise multiple search terms. In addition, search terms can comprise multiple words. In this example, the search phrase comprises three search terms. Search term 1 is “widget,” search term 2 is “feature_x,” and search term 3 is “John.” The multi-dimensional search unit 101 can determine search terms within the search phrase automatically. For example, the multi-dimensional search unit 101 may determine that each word in the search phrase constitutes a different search term. As another example, the multi-dimensional search unit 101 may determine search terms based on delimiters (e.g., commas, periods, semicolons, colons, etc.) in the search phrase. In addition, the multi-dimensional search unit 101 can determine search based on user preferences, past search behavior, heuristics, etc. The multi-dimensional search unit 101 can determine search terms manually. For example, a user may indicate search terms by entering the search terms into separate text boxes.

At stage C, the multi-dimensional search unit 101 performs a search on documents in a document storage 107 for each search term. The document storage may exist on a local device, a network device, an external device, etc. Documents can comprise files 109 (e.g., word processor documents, spreadsheets, presentation documents, text documents, etc), emails 111, chat logs 113, etc. The result(s) of the search can be presented as hyperlinks, shortcuts, thumbnails, etc. that reference documents that include some or all of the search terms.

At stage D, the multi-dimensional search unit 101 determines individual relevancies corresponding to each search term for each search result. An individual relevancy indicates how relevant a search result is to a search term. In this example, the search returned search results “test results report” 115, “email: widget” 117, “chat log 1” 119, and widget user manual 121. Although four search results are depicted, additional search results may have been returned. The individual relevancies for search term 1 are 79 for “test results report” 115, 78 for “email: widget,” 57 for “chat log 1,” and 95 for “widget user manual.” The individual relevancies for search term 2 are 82 for “test results report” 115, 56 for “email: widget,” 80 for “chat log 1,” and 45 for “widget user manual.” The individual relevancies for search term 3 are 34 for “test results report” 88, 78 for “email: widget,” 90 for “chat log 1,” and 10 for “widget user manual.” The individual relevancies may be based on a number of times each search term appears in the search result, where the search term appears in the search result (e.g., title, header, body, subject, etc.), a frequency of appearance of the search term relative to other words, etc. In this example, the individual relevancies are expressed as a percentage of a maximum individual relevancy. However, the individual relevancies may be expressed by any numerical value.

The multi-dimensional search unit 101 also determines an overall relevancy for each search result. The overall relevancy is based on the individual relevancies. In this example, the overall relevancy represents a distance from a search result having maximum individual relevancies. The overall relevancy can be computed by Equation 1.

$$overall relevancy = \sqrt{{( x - x 1 )}^{2} + {( y - y 1 )}^{2} + {( z - z 1 )}^{2}} \qquad Equation 1$$

Variables x1, y1, and z1 represent the individual relevancies for search term 2, search term 3 and search term 1, respectively. Constants x, y, and z are the maximum individual relevancies and are equal to 100 in this example. In this example, the overall relevancies are 72 for “test results report” 115, 52 for “email: widget,” 48 for “chat log 1,” and 106 for “widget user manual.” The search result “chat log 1” 119 is the most relevant because the distance from the search result with the maximum relevancy is the least.

At stage E, the multi-dimensional search unit 101 plots the individual relevancies on a heatmap. A heatmap comprises a graphical representation of the individual relevancies. Because there are three search terms in this example, the heatmap comprises a three-dimensional surface plot. Search term 1 is depicted along the x-axis of the heatmap, search term 3 is along the y-axis, and search term 2 is along the z-axis. The heatmap is color-coded based on the overall relevancy. In this example, the color-coding is based on a gray scale. The color-coding can be based on a red green blue (RGB) color scale. The heatmap allows the user to visualize the relationships between the individual relevancies, and allows the user to make an informed selection of the most relevant document(s). In this example, a user may be trying to recall a conversation the user had with John about feature_x of the widget. From the heatmap, the user can quickly determine which of the search results are the most relevant to John, while still being relevant to feature_x of the widget. From the heatmap, the user can see that “chat log 1” 119 is most relevant to John and probably contains the conversation the user was looking for.

Although examples depict heatmaps as three-dimensional surface plots, embodiments may utilize different types of heatmaps. For example, a search phrase comprises two search terms, so a heatmap of the individual relevancies may be depicted by a two-dimensional plot. The heatmap may be displayed with along with a listing of the search results and the search results can be pinpointed on the heatmap. In addition, an area of a heatmap plot can be highlighted to cause a synopsis of the search results that are plotted within the area to be displayed. As another example, a search phrase comprises five search terms. Visualizing more than three dimensions on a plot can be problematic, so a heatmap of the individual relevancies may be depicted as a matrix. A matrix-style heatmap can be depicted similar to the depiction of the search results 115, 117, 119, and 121 in FIG. 1. Cells within the matrix may be shaded based on either the individual or overall relevancies. In addition, the search results shown in the matrix may be sorted by the individual and/or overall relevancies.

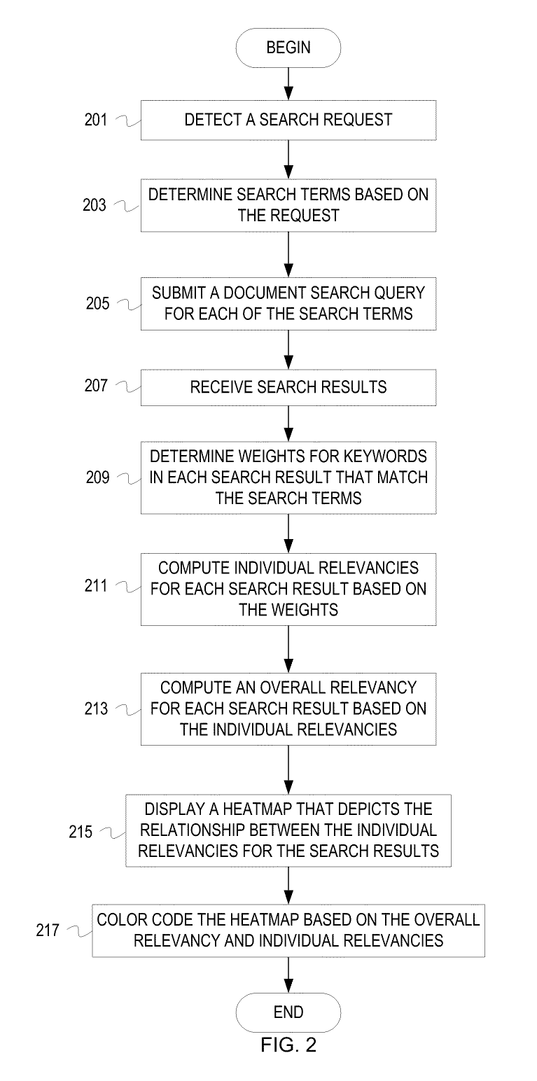

FIG. 2 is a flowchart depicting example operations for displaying a heatmap to depict relevancies of multi-dimensional search results. Flow begins at block 201, where a search request is detected. For example, a click on a search button is detected.

At block 203, search terms are determined based on a search phrase in the request. For example, each word of the search phrase is determined to be a distinct search term. Articles, conjunctions, and prepositions are not considered to be distinct search terms and may be eliminated or combined with other search phrases. As another example, the terms may be determined from search phrase by parsing the phrase based on a delimiter, such as a comma.

At block 205, a document search query is submitted for each of the search terms. Examples of documents include text files, spreadsheets, word processor files, web pages, emails, chat logs, etc. The search may be performed on document text or metadata files associated with the documents. The metadata files contain tag information related to the documents. The document search may be performed over the web, on a local machine (e.g., a search of a hard drive, a search of an email inbox, etc.), etc.

At block 207, search results are received. For example, a set of shortcuts to documents that include some or all or the search terms is received.

At block 209, weights are determined for keywords in each search result that match the search terms. The weights may be based on the number of times a matching keyword appears in a search result, the frequency of appearance relative to other words in the search result, etc. A higher weight may be given to a matching keyword that appears in the title, subject, or header of a search result than to another matching keyword in the body. If a search term is a person's name, a higher weight may be given when the person's name appears as an author or contributor of a search result than when the person's name is mentioned in text. Weighting preferences may be specified by a user or may be default values.

At block 211, individual relevancies are computed for each search result based on the weights. For example, the individual relevancies are computed as sums of the weights. As another example, the individual relevancies are averages of the weights.

At block 213, an overall relevancy is computed for each search result based on the individual relevancies. For example, the overall relevancy is computed to be a distance from a search result with maximum individual relevancies. As another example, the relevancy is computed as a sum of the individual relevancies.

At block 215, a heatmap that depicts the relationship between the individual relevancies for the search results is displayed. For example, the heatmap comprises a two-dimensional plot with the individual relevancies plotted along the x- and y-axes. As another example, the heatmap comprises a matrix with the numerical values of individual relevancies shown in cells. The heatmap assists a user in selecting appropriate search results. For example, the user may be searching “design widget feature_x.” The user is most interested in documents pertaining to “feature_x” but refines the search with “design,” and “widget.” They heatmap depicts the individual relevancies and the user can choose search results with higher individual relevancies for “feature_x.”

At block 217, the heatmap is color-coded based on the overall and individual relevancies and flow ends. For example, heatmap comprising a two dimensional plot is color-coded based on five different colors. Areas in the plot where the overall relevancy is above 80 are shaded in red, areas with relevancies between 60 and 80 are shaded in orange, areas with relevancies between 40 and 60 are shaded in yellow, areas with relevancies between 20 and 40 are shaded in green, and areas with relevancies below 20 are shaded in blue. As another example, cells in a matrix style heatmap are shaded based on the individual relevancies.

Formats of different types of documents such as emails, chat logs, web pages, text files, etc. may be different. Metadata files may be created and associated with documents to standardize format. The metadata files may be searched instead of document text. The metadata files can represent a condensed version of the documents, which may lead to more efficient searches.

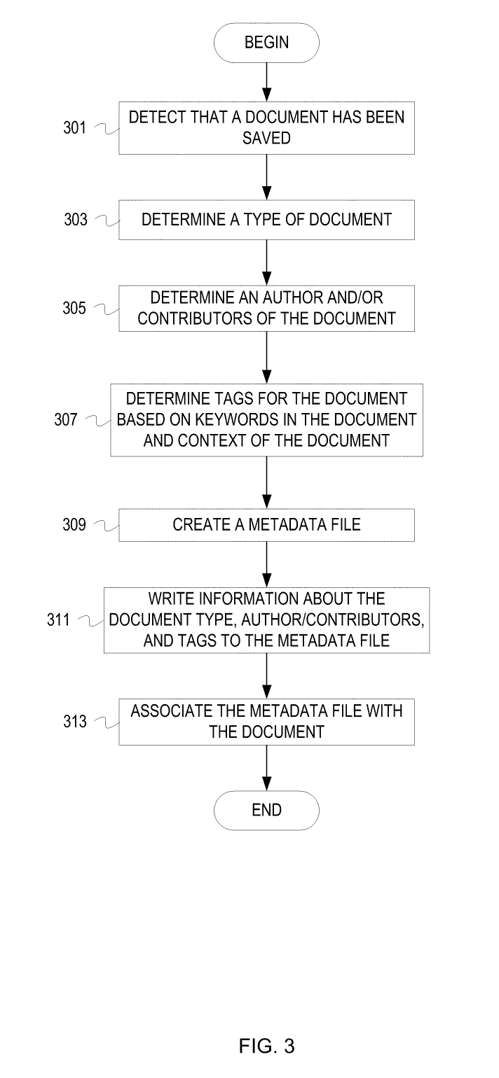

FIG. 3 is a flowchart of example operations for creating a metadata file for a document. Flow begins at block 301, where a document save is detected. For example, a click on a save button is detected. As another example, an email is received.

At block 303, a type of document is determined. Examples of document types include email, chat, text, spreadsheet, word processor, web page, etc.

At block 305, an author and/or contributors of the document are determined. For example, the author may be determined by the from line in an email. As another example, the contributors may be determined based on participants in a chat. As another example, the author may be determined based on a created by field associated with the document.

At block 307, tags for the document are determined based on keywords in the document and context of the document. Tags may be determined automatically based on a keyword analysis. Keywords may comprise words or phrases that appear in titles, subjects, body text, etc. of the document. For example, a subject of an email document is “When is the meeting to discuss the widget design.” The keyword analysis on the subject can determine that “meeting,” “discuss,” “widget,” and “design” are keywords. The keywords then will be included in the metadata as tags. When a search is performed, the tags in the metadata can be matched to the search terms. A word or phrase may not be considered as a keyword unless the word or phrase appears with a certain frequency within the document, appears in a subject or title, etc. In addition, articles, prepositions, and conjunctions would not be considered to be keywords. Tags may also be specified by a user. For example, a user may save a tag that is meaningful to the user with the document. Automatic tagging may be refined as more documents are saved, as users manually save tags, etc. Tags may also indicate a number of times the keywords appeared in the document and an indication of where the keywords appeared.

At block 309, a metadata file is created. The metadata file may exist in a separate file from the document. For example, the metadata file is an Extensible Markup Language (XML) file. The metadata may also be embedded within the document.

At block 311, information about the document type, author/contributors, and tags are written to the metadata file.

At block 313, the metadata file is associated with the document and flow ends. For example, a reference to the metadata file is embedded in the document. As another example, the metadata is embedded in the document.

It should be understood that the depicted flowcharts are examples meant to aid in understanding embodiments and should not be used to limit embodiments or limit scope of the claims. Embodiments may perform additional operations, fewer operations, operations in a different order, operations in parallel, and some operations differently. For instance, referring to FIG. 2, the operations for displaying a heatmap and color-coding the heatmap may occur in parallel. In addition, the graphical representation of relevancies can reference the documents. For example, a multi-dimensional search unit can encode areas of the heat map as links to the corresponding document. As another example, the documents can be indicated the heat map by a labeled point. Referring to FIG. 3, the operations for determining a type, determining an author and/or contributors, and determining tags may be interchanged.

Embodiments may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

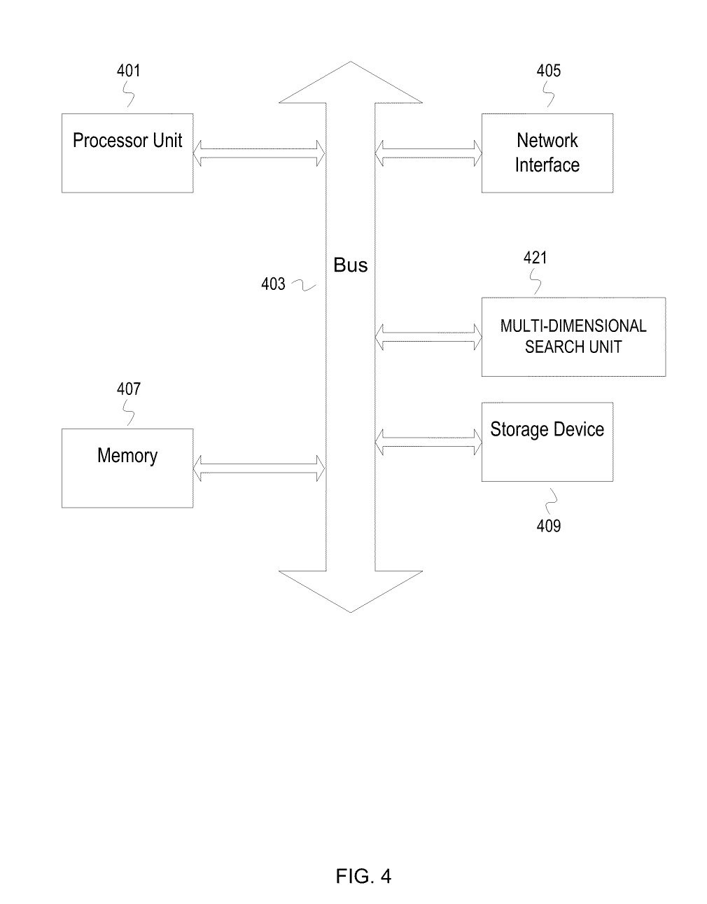

FIG. 4 depicts an example computer system. A computer system includes a processor unit 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport®, InfiniBand®, NuBus, etc.), a network interface 405 (e.g., an ATM interface, an Ethernet interface, a Frame Relay interface, SONET interface, wireless interface, etc.), and a storage device(s) 409 (e.g., optical storage, magnetic storage, etc.). The computer system also includes a multi-dimensional search unit 421 that determines search terms from a search phrase, performs a document search for each of the search terms, determines individual relevancies for each search result with respect to the search terms, and displays a heatmap that depicts the relations between the individual relevancies for the search results. Any one of these functionalities may be partially (or entirely) implemented in hardware and/or on the processing unit 401. For example, the functionality may be implemented with an application specific integrated circuit, in logic implemented in the processing unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 409, and the network interface 405 are coupled to the bus 403. Although illustrated as being coupled to the bus 403, the memory 407 may be coupled to the processor unit 401.

While the embodiments are described with reference to various implementations and exploitations, it will be understood that these embodiments are illustrative and that the scope of the inventive subject matter is not limited to them. In general, techniques for displaying relevancy of results from multi-dimensional searches using heatmaps as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer implemented method comprising:
determining a plurality of search terms from a search phrase;
performing a search for each of the plurality of search terms on a plurality of documents;
determining individual relevancies of each of the plurality of documents with respect to each of the plurality of search terms;
computing an overall relevancy for each of the plurality of documents based on the individual relevancies thereof, and
displaying a graphical representation of the individual relevancies and the overall relevancies.

2. The computer implemented method of claim 1, wherein said determining the plurality of search terms from the search phrase is based on delimiters, user preferences, past search behavior, and heuristics.

3. The computer implemented method of claim 1, wherein the graphical representation comprises a heatmap that indicates the search terms in relation to the corresponding individual relevancies.

4. The computer implemented method of claim 1, wherein the plurality of documents comprise one or more of text documents, word processor documents, web pages, emails, chat logs, spreadsheets, and presentation documents.

5. The computer implemented method of claim 1, wherein said determining individual relevancies of each of the plurality of documents with respect to each of the plurality of search terms comprises determining weights for each appearance of each of the plurality of search terms in the plurality of documents, wherein the weights are based on at least one of numbers of times each of the plurality of search terms appear, frequencies of appearance of each of the plurality of search terms, and locations of each of the plurality of search terms within the plurality of documents.

6. The computer implemented method of claim 1, wherein the search is performed on at least one of document text, and a metadata file, where the metadata file is a condensed version of a document.

7. The computer implemented method of claim 1 further comprising:
detecting that a document has been saved;
determining a document type of the document that has been saved;
determining a contributor to the document, wherein the contributor is one of an author of the document, a creator of the document, and a participant in a chat;
determining tags of the document based on a plurality of keywords in the document and context of the document;
creating a metadata file, where the metadata file is a condensed version of the document; and
writing information about the document type, the contributor, and the tags to the metadata file.

8. A computer program product for displaying relevancy of results from multi-dimensional searches, the computer program product comprising:
a computer usable medium having computer usable program code embodied therewith, the computer usable program code comprising:
computer usable program code configured to,
determine a plurality of search terms from a search phrase;
perform a search for each of the plurality of search terms on a plurality of documents;
determine individual relevancies of each of the plurality of documents with respect to each of the plurality of search terms;
compute an overall relevancy for each of the plurality of documents based on the individual relevancies thereof, and
display a graphical representation of the individual relevancies and the overall relevancies.

9. The computer program product of claim 8, wherein the computer usable program code being configured to determine individual relevancies of each of the plurality of documents with respect to each of the plurality of search terms is based on delimiters, user preferences, past search behavior, and heuristics.

10. The computer program product of claim 8, wherein the graphical representation comprises a heatmap that indicates the search terms in relation to the corresponding individual relevancies.

11. The computer program product of claim 8, wherein the computer usable program code being configured determine individual relevancies of each of the plurality of documents with respect to each of the plurality of search terms comprises the computer usable program code being further configured to determine weights for each appearance of each of the plurality of search terms in the plurality of documents, wherein the weights are based on at least one of numbers of times each of the plurality of search terms appear, frequencies of appearance of each of the plurality of search terms, and locations of each of the plurality of search terms within the plurality of documents.

12. The computer program product of claim 8 comprises the computer usable program code being further configured to:
detect that a document has been saved;
determine a document type of the document that has been saved;
determine a contributor to the document, wherein the contributor is one of an author of the document, a creator of the document, and a participant in a chat;
determine tags of the document based on a plurality of keywords in the document and context of the document;
create a metadata file, where the metadata file is a condensed version of the document; and
write information about the document type, the contributor, and the tags to the metadata file.

13. A computer program product for displaying relevancy of results from multi-dimensional searches using heatmaps, the computer program product comprising:
a computer usable medium having computer usable program code embodied therewith, the computer usable program code comprising:
computer usable program code configured to,
detect a search request for a search phrase;
determine that the search phrase comprises a plurality of search terms;
perform a search for the search phrase;
determine weights for each appearance of each of the search terms in each of the search results;
compute individual relevancies of each search result with respect to each of the plurality of the search terms based on the weights;
compute an overall relevancy based on the individual relevancies;
display a heatmap to graphically depict the individual and overall relevancies.

14. The computer program product of claim 13, wherein the computer usable program code being configured to color-code the heatmap based on the individual relevancies and the overall relevancies.

15. An apparatus comprising:
one or more processing units;
a network interface; and
a multi-dimensional search unit operable to,
determine a plurality of search terms from a search phrase;
perform a search for each of the plurality of search terms on a plurality of documents;
determine individual relevancies of each of the plurality of documents with respect to each of the plurality of search terms;
compute an overall relevancy for each of the plurality of documents based on the individual relevancies thereof; and
display a graphical representation of the individual relevancies and the overall relevancies.

16. The apparatus of claim 15, wherein the multi-dimensional search unit being operable to determine individual relevancies of each of the plurality of documents with respect to each of the plurality of search terms is based on delimiters, user preferences, past search behavior, and heuristics.

17. The apparatus of claim 15, wherein the graphical representation comprises a heatmap that indicates the search terms in relation to the corresponding individual relevancies.

18. The apparatus of claim 15, wherein the plurality of documents comprise, one or more of, text documents, word processor documents, web pages, emails, chat logs, spreadsheets, and presentation documents.

19. The apparatus of claim 15, wherein the multi-dimensional search unit being operable to determine individual relevancies of each of the plurality of documents with respect to each of the plurality of search terms comprises the multi-dimensional search unit being further operable to determine weights for each appearance of each of the plurality of search terms in the plurality of documents, wherein the weights are based on at least one of numbers of times each of the plurality of search terms appear, frequencies of appearance of each of the plurality of search terms, and locations of each of the plurality of search terms within the plurality of documents.

20. The apparatus of claim 15 comprises the multi-dimensional search unit being further operable to:
detect that a document has been saved;
determine a document type of the document that has been saved;
determine a contributor to the document, wherein the contributor is one of an author of the document, a creator of the document, and a participant in a chat;
determine tags of the document based on a plurality of keywords in the document and context of the document;
create a metadata file, where the metadata file is a condensed version of the document; and
write information about the document type, the contributor, and the tags to the metadata file.
